(19) United States
(12) Patent Application Publication
(10) Pub. No.: US 2017/0284121 A1
(43) Pub. Date: Oct. 5, 2017

(54) PROCESS FOR CREATING MEMORIAL DISPLAY AND MEMORIAL DISPLAY CREATED THEREBY

(71) Applicants: John D. Rudd, East Peoria, IL (US); Dwayne Atherton, Spring Bay, IL (US)

(72) Inventors: John D. Rudd, East Peoria, IL (US); Dwayne Atherton, Spring Bay, IL (US)

(21) Appl. No.: 15/475,756

(22) Filed: Mar. 31, 2017

Related U.S. Application Data
(63) Continuation of application No. 62/318,308, filed on Apr. 5, 2016.

(51) Int. Cl. E04H 13/00; A61G 99/00

(52) U.S. Cl. CPC E04H 13/003; A61G 99/00

(57) ABSTRACT

The process in preserving and protecting pictures and mementos from the natural elements. The memorial is comprised of a base (Which could be many materials. Wood, concrete, resin, steel etc.), A Picture or memento that is sealed the fully encapsulated in a clear UV resistant resin. The finished memorial can be used indoors or outdoors. As the picture or memento is sealed and fully encapsulated in resin protecting it from the elements.

### TECHNICAL FIELD

The present invention generally relates to memorial displays and in particular to memorial displays with photographic or other images.

### BACKGROUND OF THE INVENTION

The present invention generally relates to a process for creating memorial displays with photographic or other images, and the memorial display created through that process.

The invention serves the purpose of preserving and protecting pictures and other mementos from the everyday elements. The pictures will be sealed from the elements in a clear resin using this process. The process being used is for indoor and outdoor use. Examples of use include Headstones, Benches, Bar top, Tabletop, Stepping stones, Ponds, Gardens, Pet memories, etc. Anything you can imagine to encapsulate precious memories.

Many Base materials could be used. Examples: Concrete (needs to be reinforced with wire, mesh, or rebar, Granite, Metal, Fiberglass, Full Thickness Resin, Plastic, Wood, etc..

### BRIEF DESCRIPTION OF THE DRAWINGS

FIG. 1 is a block diagram and schematic of a memorial display according to an exemplary embodiment of the present invention.

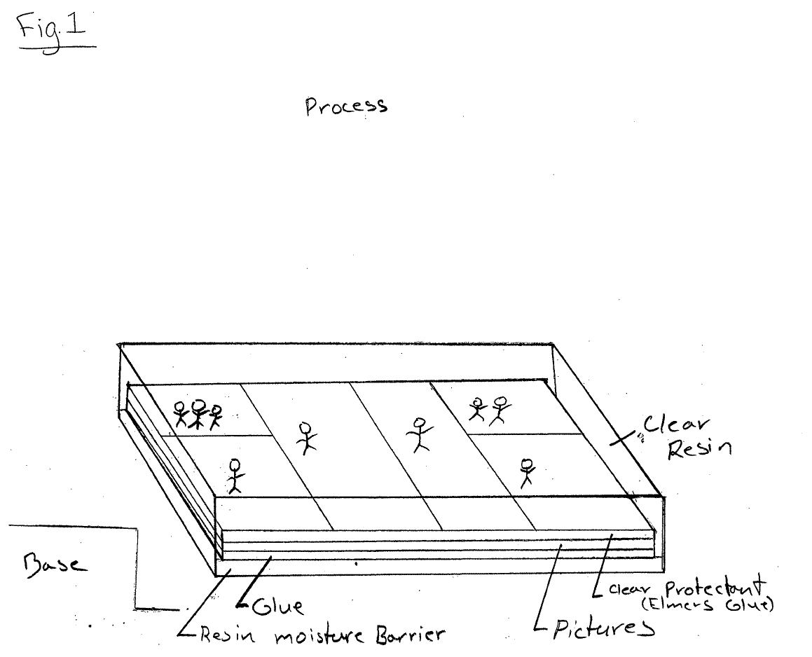

FIG. 2 is a block diagram and schematic of a second embodiment of a memorial display and process of creating the memorial display according to an exemplary embodiment of the present invention.

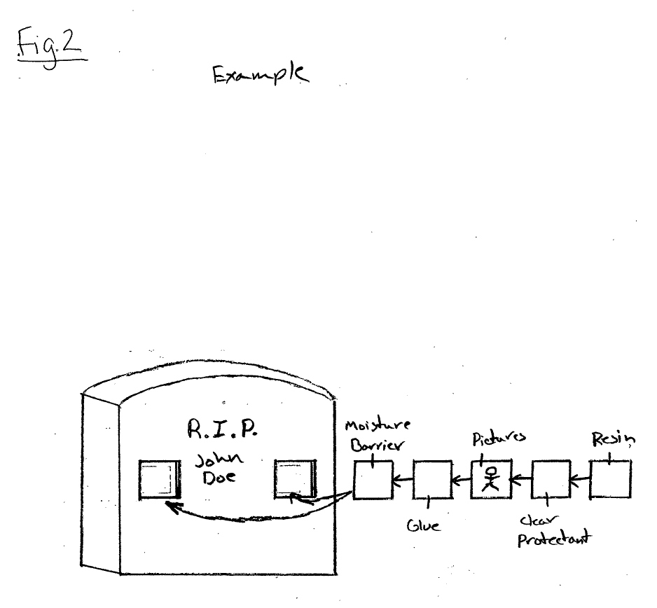

FIG. 3 is a block diagram and schematic of a third embodiment of a memorial display and process of creating the memorial display according to an exemplary embodiment of the present invention.

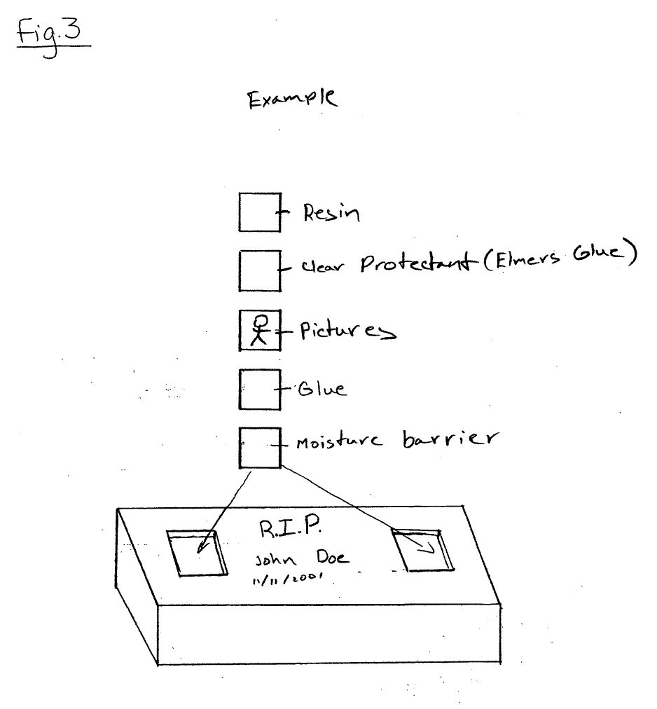

FIG. 4 is an expanded view and block diagram of a fourth embodiment of a memorial display according to an exemplary embodiment of the present invention.

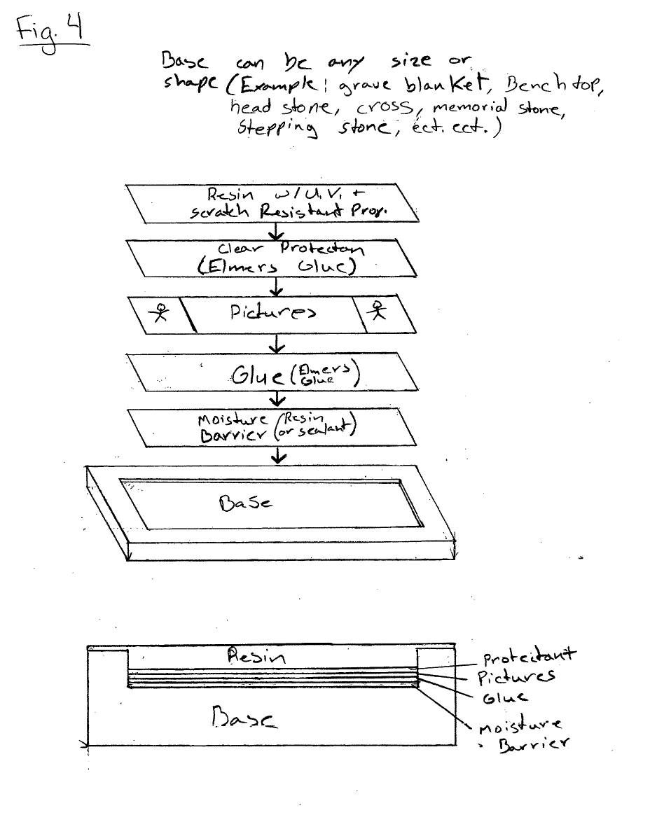

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

The following is an exemplary embodiment of a process to create a memorial display with photographic and other images which are protected from the environmental elements

Step 1: Choose the Base you would like your pictures and or mementos place in or on. I Example: Headstone, Bench, Bar top, Stepping Stone, Tabletop, Etc. Etc.

Step 2: Choose the Pictures and or mementos you would like in or on the base you choose.

Step 3: Decide on the arrangement of pictures and or mementos.

Step 4: Pour or spray a moisture barrier down on or in the base you choose. Example Sealant or Resin.

Step 5: Glue pictures down to the moisture barrier in or on the Base (memorial).

Step 6: Cover or pour a clear drying protectant over the pictures. Such as Elmer's glue or any other Protectant that will not harm the pictures or mementos.

Step 7: After glue and/or protectant has dried clear and cured, mix a clear resin that has scratch and U.V. resistant properties. Pour this resin over the pictures to the thickness desired. (Depth not limited)

Step 8: Use a heat source such as propane, heat gun, or whatever the manufacturer of the resin recommends for removing air bubbles.

Step 9: Let resin cure to manufacturer's specifications.

Picture memorial is then complete with scratch and U.V. resistant properties that have a lifetime of memories.

Other uses: flower pots, business logos in concrete, stepping stones, house numbers, countertops, bars, pet graves, flooring, serving trays, casters Etc. Etc.

Could be used as a grave blanket with interlocking pieces to make as large or small as you want to.

Could incorporate lighting such as led or fiber optics to illuminate pictures.

The claimed invention is:

1. For the purpose of preserving and other mementos from everyday natural elements. The pictures and or mementos will be sealed then fully encapsulated in a clear resin using this process. Being used for indoor or outdoor use. Examples of use: Memory stones, Headstones, Benches, Bar top (countertop), Tabletop, Stepping stone, Pet memories. It is the process to encapsulate precious memories.

2. The resin used in the process has U.V. resistant properties so it can be placed outside in the sun, heat cold and will preserve the pictures and or mementos form the everyday elements from the changing seasons.

3. The process of the invention includes a Base. The base could comprised of different materials such as: Concrete, Stone, Granite, Marble, Resin, Wood, Steel, Aluminum, etc.
